(19) United States
(12) Patent Application Publication
(10) Pub. No.: US 2025/0256250 A1
(43) Pub. Date: Aug. 14, 2025

(54) METHOD OF REBLENDING AT LEAST TWO PHASES OF A FLOWABLE MATERIAL AND THE USE IN SUCH A METHOD OF A RECEIVING CONTAINER HAVING AN INSERTABLE INSERT

(71) Applicant: Henkel AG & Co. KGaA, Duesseldorf (DE)

(72) Inventor: Nicolas Riem, Fleurus (BE)

(21) Appl. No.: 19/196,230

(22) Filed: May 1, 2025

Related U.S. Application Data
(63) Continuation of application No. PCT/EP2023/079398, filed on Oct. 23, 2023.

(30) Foreign Application Priority Data
Nov. 2, 2022 (EP) 22205068.4

(51) Int. Cl. B01F 29/10; B01F 29/00; B01F 35/42

(52) U.S. Cl. CPC B01F 29/10; B01F 29/4022; B01F 35/421

(57) ABSTRACT

The invention relates to a method of reblending at least two phases of a flowable material, wherein the flowable material is disposed in a receiving container and wherein the receiving container comprises a receiving volume for the flowable material as well as a removable lid by means of which the receiving volume can be closed in a sealed manner and wherein an air-filled head space exists within the receiving volume between the flowable material received in the receiving volume and the lid; as well as to the use in such a method of a receiving container having an insertable insert.

The invention relates to a method of reblending at least two phases of a flowable material, wherein the flowable material is disposed in a receiving container and wherein the receiving container comprises a receiving volume for the flowable material as well as a removable lid by means of which the receiving volume can be closed in a sealed manner and wherein an air-filled head space exists within the receiving volume between the flowable material received in the receiving volume and the lid. The invention further relates to the use in such a method of a receiving container having an insertable insert.

In electronic component engineering, automotive applications or any other heat-generating scenario, so-called thermal gap fillers are used to fill cavities between components between which heat transfer is to take place. These are flowable materials, for example silicone pastes provided with suitable fillers, which have good thermal conductivity. The viscosity of such thermal gap fillers is usually set comparatively low to ensure good machine processability and good adaptability to a wide variety of substrate surfaces, including complex ones.

Thermal gap fillers have the disadvantage that after a certain storage period of a few months individual phases of the material separate from each other. Thus, it is usually observed that a liquid phase separates from the rest of the material matrix and settles on it. Due to the insufficient homogeneity, the properties of the material and its processability are negatively affected. At the same time, stirring the material by hand or by machine with the aim of restoring homogeneity involves the risk of introducing too much air into the material matrix, which also worsens the properties of the material. In particular, the introduction of air reduces the thermal conductivity of the material, which can make the material unusable for its intended purpose. The period of time in which the material is available for processing without any loss of quality is thus severely limited, resulting in high reject rates.

The problem described is not limited to thermal gap fillers. There are also other liquid to paste-like functional materials in which individual phases separate from one another over time and whose functionality is impaired by air entrainment during reblending.

There is thus a need for an improved mixing process that enables several phases of a flowable material that have separated from each other to be reblended without significantly affecting the quality of the material. For cost and compatibility reasons, it is desirable for the material to be reblended to remain in its original container.

### SUMMARY OF THE INVENTION

It is therefore the object of the present invention to provide an inexpensive and simple method for reblending at least two phases of a flowable material arranged in a receiving container, by which the quality of the material is not substantially reduced. It is a further object of the invention to provide a receiving container for receiving a flowable material, which can be used in the reblending method according to the invention.

These tasks are solved by a method with the features of the invention as well as by the use of a receiving container with an insertable insert in such a method according to the invention.

The invention relates to a method of reblending at least two phases of a flowable material, wherein the flowable material is disposed in a receiving container, and wherein the receiving container comprises a receiving volume for the flowable material and a removable lid by means of which the receiving volume is sealingly closable, and wherein an air-filled head space exists within the receiving volume between the flowable material received in the receiving volume and the lid, the method comprising the steps of:
a) insertion of an insert into the air-filled head space of the receiving volume, such that the volume of the head space is reduced by 30-70% by the insert;
b) closure of the receiving volume by means of the lid;
c) rotating the receiving container about at least one axis of rotation during a time interval DT to effect reblending of the phases of the flowable material;
d) removing the lid and removing the insert.

The invention further relates to the use of a receiving container having an insertable insert in such a method.

Advantageous embodiments and further developments of the invention are described below.

Provided in Embodiment 1 is a method of reblending at least two phases (3, 4) of a flowable material (2), wherein the flowable material (2) is disposed in a receiving container (1), and wherein the receiving container (1) comprises a receiving volume (5) for the flowable material (2) and a removable lid (7) by means of which the receiving volume (5) is sealingly closable, and wherein an air-filled head space (8) exists within the receiving volume (5) between the flowable material (2) received in the receiving volume (5) and the lid (7), the method comprising the steps of:-insertion of an insert (9) into the air-filled head space (8) of the receiving volume (5), such that the volume of the head space (8) is reduced by 30-70% by the insert (9),-closure of the receiving volume (5) by means of the lid (7),-rotating the receiving container (1) about at least one axis of rotation during a time interval ΔT to effect reblending of the phases (3, 4) of the flowable material (2), -removing the lid (7) and removing the insert (9).

Embodiment 2 is directed to the method according to Embodiment 1, characterized in that the insert (9) is hooked onto a rim (11) of the receiving container (1).

Embodiment 3 is directed to the method according to Embodiment 1 or 2, characterized in that the volume of the head space (8) is reduced by 45-55% by the insert (9).

Embodiment 4 is directed to the method according to any one of Embodiments 1 to 3, characterized in that the time interval ΔT is 1 to 30 minutes.

Embodiment 5 is directed to the method according to any one of Embodiments 1 to 4, characterized in that the rotation of the receiving container (1) is performed about at least two different axes of rotation.

Embodiment 6 is directed to the method according to Embodiment 5, characterized in that the rotation of the receiving container (1) takes place in a biaxial mixer.

Embodiment 7 is directed to the method according to any one of Embodiments 1 to 6, characterized in that the rotation of the receiving container (1) is performed at a rotational speed of 10-200 revolutions per minute.

Embodiment 8 is directed to use of a receiving container (1) having an insertable insert (9) in a method according to any one of Embodiments 1 to 7, wherein the receiving container (1) comprises a receiving volume (5), an insert (9) hookable onto a peripheral rim (11) of the receiving container (1) and extending into the receiving volume (5), and a removable lid (7) sealingly closing the receiving volume (5) enclosing the insert (9), and wherein the receiving container (1) is adapted to receive a flowable material (2) in the receiving volume (5) such that an air-filled head space (8) remains between the surface of the flowable material (2) and the inserted insert (9).

### BRIEF DESCRIPTION OF THE DRAWINGS

In the following, the invention is explained in more detail by means of an embodiment example and with reference to the drawing.

FIG. 1 is a schematic sectional view of a receiving container according to the invention useful in methods according to the invention.

### DETAILED DESCRIPTION OF EMBODIMENTS OF THE INVENTION

Embodiments of the invention are directed to a method of reblending at least two phases of a flowable material, wherein the flowable material is disposed in a receiving container, and wherein the receiving container comprises a receiving volume for the flowable material and a removable lid by means of which the receiving volume is sealingly closable, and wherein an air-filled head space exists within the receiving volume between the flowable material received in the receiving volume and the lid, the method comprising the steps of:
insertion of an insert into the air-filled head space of the receiving volume, such that the volume of the head space is reduced by 30-70% by the insert,
closure of the receiving volume by means of the lid,
rotating the receiving container about at least one axis of rotation during a time interval DT to effect reblending of the phases of the flowable material,
removing the lid and removing the insert.

In other words, the method according to the invention provides that before the actual reblending of the phases of the flowable material which are separated from each other, the volume of the air-filled head space which exists in the receiving container between the surface of the flowable material and the lid of the receiving container is reduced. The reduction of the volume of the head space is achieved by inserting an insert into the head space. In this case, a head space with a volume V₁ initially exists between the surface of the flowable material and the lid. By introducing the insert, the volume of the head space is reduced to a smaller volume V₂ of a head space now existing between the surface of the flowable material and the insert. In this way, there is less air in the head space of the receiving container immediately above the surface of the material to be reblended, which could be introduced into the material during the reblending process. In addition, the free moving space of the material to be reblended is restricted by the insert, the consequences of which will be explained in more detail below.

It has surprisingly been found that the quality of the reblended material depends decisively on the size of the air-filled head space existing above the surface of the material. On the one hand, this head space must have a certain minimum volume so that satisfactory blending of the material can occur at all. On the other hand, the volume of the head space must not be too large, as otherwise an excessive amount of air is introduced into the material during reblending. In this respect, a compromise must be found between a head space that is sufficiently large for the reblending process and a head space that is as small as possible with regard to the lowest possible air input in order to achieve an optimum reblending result.

By placing an insert into the head space as provided by the invention, its volume can be reduced to the desired size. The free moving space of the material during the mixing process is thus controlled and limited, and less air is introduced into the material. As a result, the quality of the material is maintained, particularly with regard to homogeneity, thermal conductivity and good processability.

To carry out the method according to the invention, after the insert has been introduced into the head space of the receiving volume, the receiving volume is sealed by the lid with the insert enclosed. In a subsequent process step, the receiving container is rotated about at least one axis of rotation during a time interval DT to effect reblending of the phases of the flowable material. Finally, the lid is removed and the insert is removed. The homogenized, reblended material is now available for further processing.

It is an advantage of the method according to the invention that the material to be reblended remains in its original container. Transferring the material to a smaller container is generally associated with quality impairments, since contamination cannot be ruled out and there is also a risk of increased air entrainment. In addition, the size of the receiving containers, for example so-called hobbocks, is standardized, so that the tools and machines used for further processing of the material are also adapted to these standard sizes and the material must therefore be kept in standard receiving containers of this size.

The method according to the invention is further characterized by the fact that it can be easily carried out by a user, since the material remains in its original container, the method involves only a few process steps and at the same time provides an excellent reblending result. If reblending were performed in a similar manner, but without the volume-reducing insert, a significant portion of the material to be reblended would be driven up the inner wall of the receiving volume due to the centrifugal forces acting on it, and would become lodged there as well as in the area of the lid. This material would have to be scraped off before further use or discarded. By reducing the volume of head space with the aid of the insert provided in accordance with the invention, the free moving space of the material to be reblended is restricted, so that this effect is also reduced.

The insert to be inserted according to the invention can be designed in different ways. It can be a solid or a hollow insert. The insert can be cylindrical and open on one side. In principle, the insert can also be disc-shaped. It is advantageous in each case that the insert is adapted in its geometry and outer contour to the inner contour of the receiving volume, so that when the insert is introduced into the receiving volume there is at most a small gap between the insert and the wall of the receiving container. In this way, flowable material can be prevented from entering the gap between the insert and the wall of the receiving container in larger quantities or from moving past the insert. Preferably, the insert is oriented inside the receiving volume such that its side facing the material to be reblended is oriented substantially parallel to the surface of the material to be reblended. The function of the insert is to control and to reduce the volume of the air-filled head space above the surface of the material to be reblended during the reblending process in a simple and cost-effective manner, so that less air is introduced into the material during reblending and the material does not lose its special properties.

According to one suggestion of the invention, the insert is hooked onto a rim of the receiving container. For example, the insert may be formed as a hollow cylindrical container with a circumferential, outwardly folded rim by which the insert may be hooked onto the rim of the receiving container. The insert can also be disc-shaped and have integrally formed suspensions which can be hooked onto the rim of the receiving container. The insert must be designed in such a way that the receiving volume can be sealed with the lid of the receiving container even when the insert is inserted.

According to the invention, the volume of the head space is reduced by 30-70% by the insert. It has been shown that within this range there is a good compromise between sufficient head space for the reblending process on the one hand and reduced air volume on the other. According to a preferred embodiment, the volume of the head space can be reduced by 45-55% by the insert.

According to one embodiment of the method according to the invention, the time interval DT during which the receiving container is rotated to reblend the phases of the flowable material is 1 to 30 minutes, preferably 8 to 12 minutes. With such a length of the time interval, on the one hand, sufficiently good reblending takes place, and on the other hand, too much air is not introduced into the material.

According to a suggestion of the invention, the receiving container is rotated about at least two different axes of rotation. In this way, a particularly good and rapid reblending of the phases separated from each other can be effected. The at least two axes of rotation can, for example, be aligned perpendicular to one another. In particular, a first axis of rotation may be oriented perpendicular to the surface of the material to be reblended and a second axis of rotation may be oriented perpendicular to the first axis of rotation. Rotation may occur sequentially about the at least two different rotational axes, or it may occur simultaneously. In this case, the resulting motion is a superposition of the rotations about the individual rotational axes.

Reblending is particularly good when using a biaxial mixer. Biaxial mixers are used, for example, for mixing paints and/or building materials such as cement, concrete and mortar. For this purpose, a container filled with a material to be reblended is clamped in the biaxial mixer and the container is then rotated during a predetermined time interval, the rotational movement being a superposition of two rotations about two mutually perpendicular axes.

According to one embodiment of the method, the receiving container is rotated at a rotational speed of 10 to 200 revolutions per minute, preferably at a rotational speed of 80 to 120 revolutions per minute. A rotational speed in this range allows good reblending of the phases of the flowable material while minimizing air entrainment.

Receiving containers, in particular hobbocks, are known on the market which are used to hold multi-component contents. A first component is accommodated in the main volume of the container, while a second component, for example a booster system, is accommodated in an insert which is hooked onto a peripheral rim of the container and extends into a head space above the first component. The second component may in turn be located in a smaller, closed receptacle which is arranged in the insert. Before processing such multi-component contents, the insert is removed from the receiving container and the second component is mixed with the first component. In these known applications, the insert serves only to keep the individual components separate until the components are mixed by a consumer. The insert has no function during the mixing of the individual components. Such inserts or hobbocks with inserts are nevertheless suitable for use in the present process according to the invention.

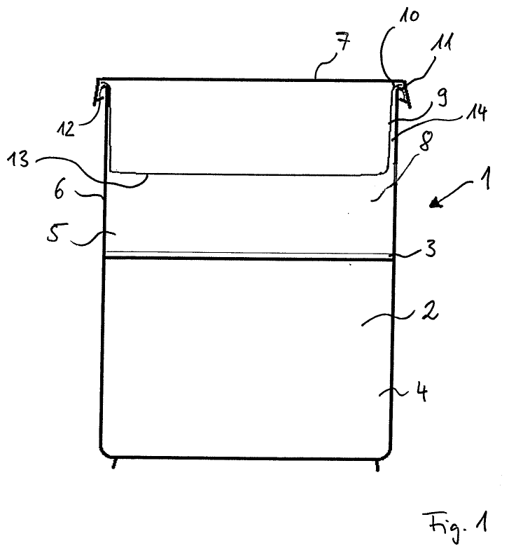

FIG. 1 shows a schematic representation of a receiving container, designated in its entirety as 1, in which a flowable material 2 is arranged. The flowable material 2, for example a thermal gap filler, has been stored in the receiving container 1 for some time, which is why a liquid phase 3 has separated from the rest of the material matrix 4 and settled on it. The flowable material 2 thus comprises the phases 3 and 4 which have separated from each other.

The receiving container 1 comprises a receiving volume 5 for receiving the flowable material 2, the receiving volume 5 being delimited by a wall 6, and a removable lid 7. The receiving volume 5 can be closed in a sealing manner by the lid 7. Within the receiving volume 5, there is an air-filled head space 8 between the surface of the deposited phase 3 of the flowable material 2 and the lid 7.

In order to reblend the phases 3 and 4 before using the material 2 and at the same time maintain the material properties of the material 2, an insert 9 is first introduced into the air-filled head space 8. This condition is shown in FIG. 1. The insert 9 is cylindrically shaped and has a circumferential, outwardly folded rim 10, with which it is hooked onto a circumferential rim 11 of the receiving container 1. The insert 9 is designed in such a way that, even when the insert 9 is inserted, the receiving volume 5 can be closed in a sealing manner by the subsequently attached lid 7. The lid 7 engages with an edge 12 behind the rim 11 of the receiving container 1. In addition, sealing means can be provided on the lid 7 and/or in the area of the rim 11 of the receiving container 1 in order to seal the receiving container 1 in the closed state and to prevent material from escaping during the reblending process.

The inserted insert 9 reduces the volume of the original head space 8. Without the inserted insert 9, the head space 8 between the surface of the phase 3 of the flowable material 2 and the lid 7 has a volume V₁ which is reduced to a smaller volume V₂ between the surface of the phase 3 of the flowable material 2 and the underside 13 of the insert 9 after the insert 9 has been inserted. The insert 9 is adapted in its geometry and outer contour to the inner contour of the receiving volume 5 in such a way that at most a very narrow gap 14 remains between the insert 9 and the wall 6 of the receiving volume 5. The free space available during the reblending process is thus essentially limited by the underside 13 of the insert 9.

For the actual reblending of phases 3 and 4, the receiving container 1 provided with insert 9 and closed by lid 7 is placed in a biaxial mixer in which it is rotated for a time interval of about 10 minutes. The rotational movement is a superposition of two rotational movements about mutually perpendicular axes of rotation. The rotational speed is about 100 revolutions per minute. Due to the reduced volume of the head space 8, only a small amount of air is introduced into the material 2 during this process, so that its properties, in particular thermal conductivity, electrical and mechanical final properties of the used material as well as its good processability, are not significantly impaired. After completion of the reblending process, the receiving container 1 is removed from the biaxial mixer, the lid 7 is taken off and the insert 9 is removed. The homogenized, reblended material 2 is now available for further processing.

The process described is suitable for reblending any liquid to pasty materials in which individual phases have separated from one another and in which it is necessary to limit the air entrainment into the material during the reblending process. With the process according to the invention, a user thus has the possibility of restoring the original homogeneity of the material in a simple manner, even after a longer storage period of a flowable material, during which various phases of the material may have separated from each other, without having to reckon with losses in the quality of the material. In this way, the possible useful life of such materials is extended and reject rates can be reduced.

1. A method of reblending at least two phases of a flowable material, wherein the flowable material is disposed in a receiving container, and wherein the receiving container comprises a receiving volume for the flowable material and a removable lid by means of which the receiving volume is sealingly closable, and wherein an air-filled head space exists within the receiving volume between the flowable material received in the receiving volume and the lid, the method comprising steps of:
a) inserting an insert into the air-filled head space of the receiving volume, such that the volume of the head space is reduced by 30-70% by the insert;
b) closure of the receiving volume by means of the lid;
c) rotating the receiving container about at least one axis of rotation during a time interval “DT” to effect reblending of the phases of the flowable material; and
d) removing the lid and removing the insert.

2. The method according to claim 1, wherein the insert is hooked onto a rim of the receiving container.

3. The method according to claim 2, wherein the volume of the head space is reduced by 45-55% by the insert.

4. The method according to claim 1, wherein the time interval “DT” is 1 to 30 minutes.

5. The method according to claim 1, wherein the rotating of the receiving container is performed about at least two different axes of rotation.

6. The method according to claim 5, wherein the rotating of the receiving container takes place in a biaxial mixer.

7. The method according to claim 1, wherein the rotating of the receiving container is performed at a rotational speed of 10-200 revolutions per minute.

8. A method of reblending at least two phases of a flowable material, using a receiving container having an insertable insert and wherein the receiving container comprises a receiving volume, an insert hookable onto a peripheral rim of the receiving container and extending into the receiving volume; and a removable lid sealingly closing the receiving volume enclosing the insert; wherein the receiving container is adapted to receive a flowable material in the receiving volume such that an air-filled head space remains between the surface of the flowable material and the inserted insert.
